(19) United States
(12) Patent Application Publication
(10) Pub. No.: US 2024/0152340 A1
(43) Pub. Date: May 9, 2024

(54) Structured Product Assembly

(71) Applicant: Google LLC, Mountain View, CA (US)

(72) Inventors: Aaron Wood, Palo Alto, CA (US); Jody Sankey, Mountain View, CA (US); John Wittrock, Brooklyn, NY (US); Aidan Wolter, Longview, TX (US)

(21) Appl. No.: 17/980,659

(22) Filed: Nov. 4, 2022

(51) Int. Cl. G06F 8/61; G06F 8/71

(52) U.S. Cl. CPC G06F 8/63; G06F 8/71

(57) ABSTRACT

The technology involves generating a deliverable image for a product. This can include selecting a set of feature options corresponding to the product and a product operating system; generating a graphical interface that includes a set of input options about the product and a set of input options about the operating system together with linkages between the sets of input options, wherein the interface restricts user selection of linkages between the product and operating system input options; receiving selection of product and operating system input options; receiving selection of linkages between the selected product and operating system options; obtaining a set of artifacts corresponding to the received selections; and assembling set of artifacts into the deliverable image for the product, the assembling including automatically linking components of the product with components of the operating system according to the selected linkages.

### BACKGROUND

Product assembly for computing devices often involves tailoring a software package to include a set of specifically configured modules and features to run on a particular operating system. Configuration tools may be used to assist in the assembly process for software for a given product. However, a developer may need detailed knowledge about the operating system to select the appropriate modules and features for the given product. The overall assembly process may involve product assembly, in which pieces of the computing platform (e.g., the operating system) are combined with software pieces for the product to create a set of items. This set of items can then be used during the process of creating a runnable software binary such as image assembly to obtain all of the compiled software components that are put together into deliverable images for installation on computing devices. A deliverable image can include a flashable system image and other optionally-installed software packages.

Updates to the operating system/platform or the product may necessitate going through the entire assembly process each time there is a change. For instance, operating system feature updates may impact the kernel configuration file, as items may have been renamed or moved. Redoing the assembly process can be resource-intensive, especially when product-related information that is external to the source code of the operating system (“out-of-tree”) needs to be incorporated with operating system/platform information that is “in-tree”. An in-tree approach involves using all of the source files of the operating system, and compiling the operating system at the same time as the product's components. In contrast, an out-of-tree approach may not have the source files for the operating system, and may not be able to compile the operating system at the same time as the product. A technical issue in such cases is that the configuration tools may only work with in-tree elements and not with out-of-tree elements. This can be particularly problematic for managed operating systems when pushing newer versions to different devices. Another technical issue is to maintain an appropriate level of security during product assembly. This may be done to ensure that platform components cannot be arbitrarily replaced with untrusted software, and that the platform only calls into product-provided components in specified places where that is expected to happen.

### BRIEF SUMMARY

Aspects of the technology include product development kit resources that give product developers a layer of tooling which includes built-in knowledge without requiring the developers to have visibility into platform details. Developers may select components at the feature level, without requiring the granularity of identifying specific software-level elements that would otherwise be required for product and image assembly. This allows the implantation of the features of the platform to evolve without coordination of the product (or vice versa). This solves the technical problem of supporting updates to the platform separately from making updates to the product. The resources do not provide users direct access to platform artifacts. They also automatically ensure that the components are selected and configured in a secure manner. This approach can help certify that a fully assembled package having both platform and product components will not execute any untrusted software, and that there have been no changes to the underlying operating system platform components.

According to one aspect, a computer-implemented method is provided that comprises: receiving, by one or more processors of a computing system, a request to generate a deliverable image for a product; selecting in response to the request, by the one or more processors, a set of feature options corresponding to the product and to an operating system associated with the product; generating according to the set of selected feature options, by the one or more processors, a graphical interface configured to present to a user, the graphical interface including a set of input options about the product and a set of input options about the operating system together with linkages between the set of input options about of the product and the set of input options about the operating system, wherein the graphical interface restricts user selection of linkages between the product input options and the operating system input options; receiving selection of one or more product input options and one or more operating system input options; receiving selection of linkages between the selected one or more product options and selected one or more operating system options; obtaining from one or more artifact stores, by the one or more processors, a set of artifacts corresponding to the received selection of one or more product input options and one or more operating system input options; and assembling, by the one or more processors, the obtained set of artifacts into the deliverable image for the product, the assembling including automatically linking components of the product with components of the operating system according to the selected linkages.

In one example, assembling the set of artifacts into the deliverable image for the product includes validating an assembly configuration to ensure that a set of correct artifacts are present to produce the deliverable image. Alternatively or additionally, the graphical interface generated to include the set of input options about the operating system does not include any platform-internal components of the operating system. Alternatively or additionally, obtaining the set of artifacts includes retrieving product-related artifacts from given ones of the one or more artifact stores that are associated with the product. Here, obtaining the set of artifacts may further include retrieving operating system-related artifacts directly from an operating system artifact store. And the one or more artifact stores associated with the product may include at least one of a product artifact store, an external artifact store, or a driver artifact store.

Alternatively or additionally to the above, assembling the set of artifacts into the deliverable image for the product may include constraining one or more configuration values in the deliverable image. Here, the one or more configuration values may include at least a pair of configuration values, and constraining the one or more configuration values would then include preventing the pair of configuration values from being used with one another. Alternatively or additionally, constraining the one or more configuration values includes restricting access for a given resource to specific operating system components.

Alternatively or additionally to the above, any artifacts from the set of artifacts corresponding to the one or more operating system input options may be hashed operating system components. Alternatively or additionally, the method may further comprise: receiving a request to modify the deliverable image; in response to receiving the request, updating a configuration file for the deliverable image; and compiling a modified version of the deliverable image without recompiling any artifacts associated with the operating system.

Alternatively or additionally to the above, the set of input options about the product may correspond to compiled components for one or more product features. Alternatively or additionally, the method may further comprise storing the deliverable image in a product release archive. Alternatively or additionally, the method may further comprise sending the deliverable image to one or more product devices for installation thereon.

According to another aspect, a system is provided that comprises a set of artifact stores each configured to store a specific type of software component, and one or more processors operatively coupled to the set of artifact stores. The one or more processors are configured to: receive a request to generate a deliverable image for a product; select, in response to the request, a set of feature options corresponding to the product and to an operating system associated with the product: generate, according to the set of selected feature options, a graphical interface configured to present to a user, the graphical interface including a set of input options about the product and a set of input options about the operating system together with linkages between the set of input options about of the product and the set of input options about the operating system, wherein the graphical interface is configured to restrict user selection of linkages between the product input options and the operating system input options; receive selection of one or more product input options and one or more operating system input options; receive selection of linkages between the selected one or more product options and selected one or more operating system options; obtain, from the set of artifact stores, a set of artifacts corresponding to the received selection of one or more product input options and one or more operating system input options; and assemble the obtained set of artifacts into the deliverable image for the product, the assembly including automatic linking of components of the product with components of the operating system according to the selected linkages.

In one example, assembly of the set of artifacts into the deliverable image for the product includes validation of an assembly configuration to ensure that a set of correct artifacts are present to produce the deliverable image. Alternatively or additionally, obtaining the set of artifacts may include retrieval of product-related artifacts from one or more artifact stores of the set of artifact stores associated with the product. Alternatively or additionally, assembly of the set of artifacts into the deliverable image for the product may include constraint of one or more configuration values in the deliverable image. Here, the constraint of the one or more configuration values may include restriction of access for a given resource to specific operating system components.

Alternatively or additionally to the above, the one or more processor may be further configured to: receive a request to modify the deliverable image; in response to receiving the request, update a configuration file for the deliverable image; and compile a modified version of the deliverable image without recompiling any artifacts associated with the operating system.

### BRIEF DESCRIPTION OF THE DRAWINGS

FIG. 1 is a process diagram in accordance with aspects of the technology.

FIG. 2 illustrates use of an assembly tool in accordance with aspects of the technology.

FIGS. 3A-B illustrates a graphical interface in accordance with aspects of the technology.

FIGS. 4A-C illustrates example computing devices which can be employed in accordance with aspects of the technology.

FIG. 5 illustrates a block diagram of an example computing device which can be employed in accordance with aspects of the technology.

FIGS. 6A-B illustrate a system for use with aspects of the technology.

FIG. 7 illustrates a method in accordance with aspects of the technology.

### DETAILED DESCRIPTION

A streamlined product development tool enables developers to select components at the feature level in such a way that product-related components and platform components can be efficiently integrated into a deliverable image. The deliverable image can then be installed on many computing devices for a given product type. Product developers can assemble and provide deliverable images in a way that is decoupled from platform releases, and in which no changes are made to the underlying platform components. This can be done via a managed operating system approach.

For instance, a wireless communication configuration utilized by a platform can be updated on a user's product such as an in-home assistant (e.g., via an over-the-air update) without impacting the product-specific features. In a conventional approach, the developer would need to identify every wireless communication component such as drivers, configuration files, etc., and then adjust the configuration if any component were renamed. This could be time consuming, and the developer may make selections that could enable execution of untrusted software elements or otherwise not be able to determine which selections should be made in order to configure the system as desired.

In contrast, a product developer kit approach as described herein allows a developer to identify the minimum set of features needed from different categories. Then the identified feature set is used by a product developer kit to select the individual cluster(s) of components necessary to support the wireless communication service (or another technical element that will be supported by the product). By way of example, the developer would name the high-level features they need, and the tool knows which components within the platform are required to fulfill those requests for features, which can include corresponding drivers, configuration files and/or other components. The tool automatically enables a product assembly process to construct a bootable, flashable, updatable package. Developers can use the tool to change the capabilities of the platform without recompiling or using runtime flags, which provides powerful control to the developer. The product assembly process can be used to ensure that appropriate linkages and permissions are set so that untrusted software will not be executed. Platform components are hashed so that one can confirm that no changes have been made to the underlying operating system.

### Example Approaches

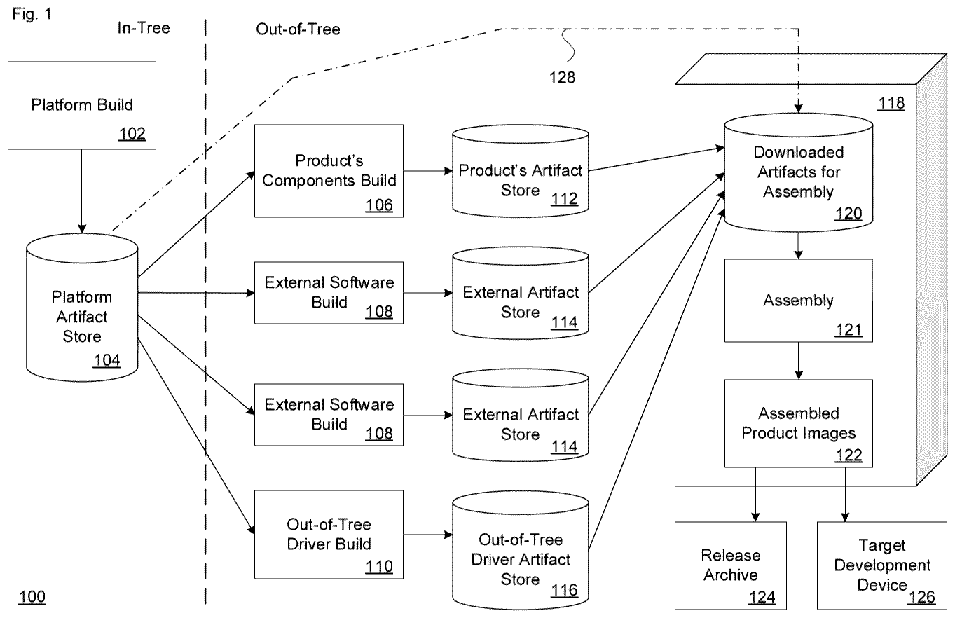

FIG. 1 illustrates an example 100 of a high-level product assembly process in accordance with aspects of the technology, in which the platform (e.g., according to a specific operating system) is “in-tree”, and the product is “out-of-tree”. At block 102, a platform build is conducted. This may have been done previously by an operating system developer. An operating system SDK and artifacts associated with the operating system may be stored in platform artifact store 104. This storage may include signed metadata for the operating system and/or individual artifacts.

On the out-of-tree side of FIG. 1, there may be a number of different build elements, including a product's component build 106, external software build(s) 108, and an out-of-tree driver build 110. The builds generate compiled components (artifacts), and the output from build elements 106-110 can be maintained in a product's artifact store 112, external artifact store(s) 114, and out-of-tree driver artifact store 116, respectively. Since out-of-tree software is configured to target the platform, the platform provides instructions, tools, libraries, etc., to the out-of-tree build systems to use. This is shown via the flow from the platform artifact store 104 to the build blocks 106, 108 and 110.

For instance, the product's artifact store 112 may include a compiled component for a particular product feature. By way of example only, this could be a step counter, blood pressure monitor, or other module for use in a wearable device. The external artifact store(s) 114 may include compiled third-party drivers. In contrast, the platform artifact store 104 may maintain compiled communication components of the operating system (e.g., a network stack and/or BlueTooth™, WiFi or near-field communication (NFC) module). A developer can use the product assembly tool to pick the correct prebuilt items from the stores.

The artifacts are sent to a product assembly environment 118, where then can be incorporated into a product image based on what features have been selected.

By way of example, a user, such as a product developer, may use one or more product development tools to choose which components associated with the operating system are to be incorporated into a product software package. The user may be presented with a curated set of features that can be selected. The features can relate to hardware options or other features associated with the platform, such as whether to enable one or more communication options for the product (e.g., BlueTooth™, WiFi and/or NFC). There may also be product-specific features. The selected features may be stored in a file, such as a configuration file. By way of example, the configuration file may be a JavaScript Object Notation (json) type file, although other file types may be employed. Based on the user selections in the configuration file, the product assembly environment 118 downloads the necessary artifacts and any other associated information, such as a platform SDK, as shown at block 120.

A configuration assembly tool or other program can be run at block 121 that produces an assembled product image at block 122. According to one aspect of the technology, the assembly tool may be part of the platform SDK itself. The assembly process can include validating the assembly configuration to ensure the correct artifacts are present to produce the desired image and linking together configuration, product-provided packages, drivers, and the kernel (among other artifacts) into an operating system volume manager (FVM) image, which is configured to be flashable to a device. This includes automatically ensuring that components for the product image will function in a tightly locked-down mode, in which untrusted software will not be executed, and software components will only be fetched from a trusted location.

The process can produce verified boot artifacts (e.g., which are hashed) to ensure the image can boot securely on the device, and can also produce an update package, which will allow existing devices to take an over-the-air (OTA) update to this new version. Once a product image is created at block 122, it may be stored in a release archive 124 for rollout to a set of devices “in the wild” and/or to a target development device at block 126 for evaluation by the developer. Furthermore, as shown by dash-dot line 128, there may be a direct link between the platform artifact store 104 to block 120. By way of example, the platform components may be constructed in-tree, and then published to a platform component store that is then used by both the builds of blocks 106-110, and also used directly by the assembly step 121 itself (via direct downloading into block 120).

After a product image has been created, a developer may decide to replace, change or otherwise modify it. For instance, the developer may select a newer version of a driver or select a WiFi communication feature instead of a Bluetooth™ communication feature. By way of example, the configuration file may be updated to add packages to a product package list. Assembly is performed to incorporate the modified components (to construct a new image for the product from the modified configuration), and then the product image is flashed to deploy it to a device. Such modification to the product image can be done without recompiling any operating system artifacts (e.g., no need to recompile the entire kernel). The only required step here would be a recombination of already-compiled artifacts into a new image.

This is a powerful technical solution that avoids a complete recompilation of the operating system (platform) features when changes are made to product features (or vice versa). In particular, none of the hashes of security-critical code has changed, which means that the resulting image's security properties will be easier to verify. The assembly process is much faster than recompiling an entire operating system image. If a product owner needs support, the team managing the operating system would know that the developer is running the code originally produced by the operating system team, with no deviation. Furthermore, updates may be made to the platform and to the product separately.

One aspect of the technology limits developer options while having the assembly tool automatically make the appropriate linkages (without developer input) to ensure the process works correctly and that untrusted software cannot be utilized. The approach creates a “product/platform boundary”. The boundary allows for varying what is on one side without needing the other to be aware of the change. For instance, it allows constraining the operation of the system to more-secure modes. It also allows the values used to configure the platform to be validated as within expected (e.g., tested) ranges, and that platform components are not receiving unvetted, potentially invalid, inputs.

This can be achieved through a few mechanisms. First, the system is able to control the contents of certain configuration values in the image, such not allowing them to contain arbitrary inputs from the developer, but only values that are constrained by the assembly tool. Second, in places where a set of components can be given access to some resource, the assembly tool uses the knowledge of what is “from the platform” versus what is “from the product” to ensure that only specific platform components are given access to that resource. In addition, components provided by the developer (referred to as product components) may only be connected to the platform in very specific points where the platform has been designed to have product components attached.

With regard to constraining values, the assembly tool can contain logic within the distributed tool which prevents certain values being used with each other. For instance, it may be impossible to have two update checkers on the system, so the tool's parsing of the configuration parameters will prevent that occurring. However, it may be possible to have two WiFi chipsets, so the assembly tool should allow that. Configuration parameter schemas (for mutual exclusion of values, etc.) may be designed on a case-by-case basis.

For differentiation between “from the platform” and “from the product”, the assembly tool may only support how to configure the platform. In other words, it is distributed by the platform and so has no knowledge of how a product works. It can be used to create a product, but may not have built-in schemas for configuring any given product. A product can be built up from a series of primitives provided by the platform, like product packages, product components, and product configurations of platform features. That set of primitives may be tightly constrained.

The approach discussed herein may limit the connection of product components to the platform at specific points: By way of example, the platform may deliberately limit the platform configuration surface. For instance, the platform may explicitly disallow two update check packages because it would likely be incorrect or otherwise cause an error. This is a key difference between “image assembly”, which can take any valid set of packages and put them together into an image, and “product assembly”, which has a semantic understanding of how the platform should be configured. Product assembly (the tool being provided to products) is implemented using image assembly, but image assembly may not be exposed to products unless there are particular reasons for circumventing what the platform deliberately provides.

Thus, it can be seen that while the assembly tool itself has intimate knowledge of the platform, it is configured to effectively present certain aspects to the user as a black box, which provides to the user only a very reduced set of ways that the product can configure things. Thus, instead of allowing the product's software to connect to any part of the platform, the assembly tool would instead only allow the product to connect at pre-defined places, using proscribed interfaces, e.g., so that the product is only able to communicate with the platform in the manner that has been deemed safe and tested. And because the assembly tool contains its own logic about what is/is not allowed, the assembly tool is able to enforce the mutual exclusivity of options.

As noted above, the approach may include validating the assembly configuration to ensure the correct artifacts are present and properly linking together. In one scenario, a user interface tool provides the developer with a curated set of features from which to choose, including a set of input options about the product and a set of input options about the operating system. For instance, in order to build a product image, there may be dozens or hundreds of packages with even more files that would typically be included in a configuration data package. There may be dozens of kernel boot components and hundreds of files to put into a boot file system. Thus, it could be possible in a conventional approach for the developer to have hundreds or even thousands of elements to evaluate and select. In contrast, the curated set of features may omit any platform-internal components, and may also omit very low-level options such as memory configurations or security mechanisms. Here, the tool may provide the developer with the ability to input a minimal amount of information about the product (e.g., a set of hardware specifications or other product requirements), and options for high-level operating system features to include or exclude (e.g., WiFi support, automatic update sources, and any/or additional hardware drivers that may be needed). This may include providing an SDK for the operating system to select the needed hardware options to include in a configuration file.

By way of example, this could include providing a communication option where the developer may choose one or more communication elements (e.g., Bluetooth™, WiFi or NFC). The developer does not need to know how these particular elements would interoperate with the operating system components. In fact, the tool may limit (or prevent) the ability of the developer to select elements and linkages to avoid the potential for executing untrusted software. For example, the developer may not be provided with direct access to platform artifacts.

Rather, the tool would evaluate the product, the selected software element(s) and then automatically make the appropriate connections for assembly. For instance, this could include selecting an appropriate driver for use with a Bluetooth® stack. The assembly would connect the driver and the stack together in a secure manner, in which an audit could confirm that the integrity of the code is intact and that nothing has been changed, resulting in a trusted relationship.

In one scenario, the user interface tool may be presented in the manner of a command line prompt. Here, by way of example, the developer may enter information about the particular feature, such as: {feature_set_level: “minimal”, build_type: “user” features: [“bluetooth”. “network stack”,]}. In another scenario, a graphical interface may include icons to select specific features and other elements to be incorporated into the product image.

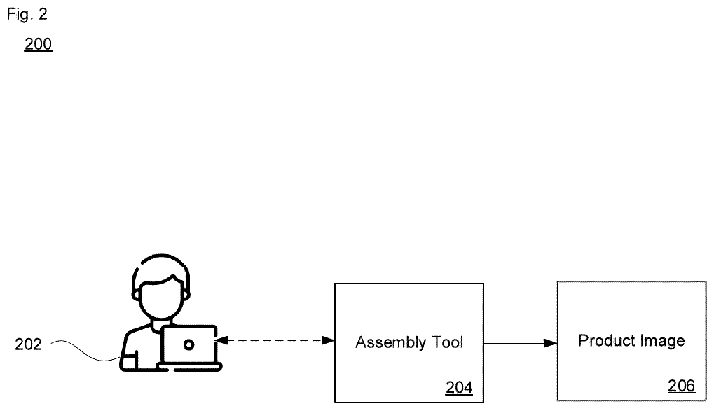

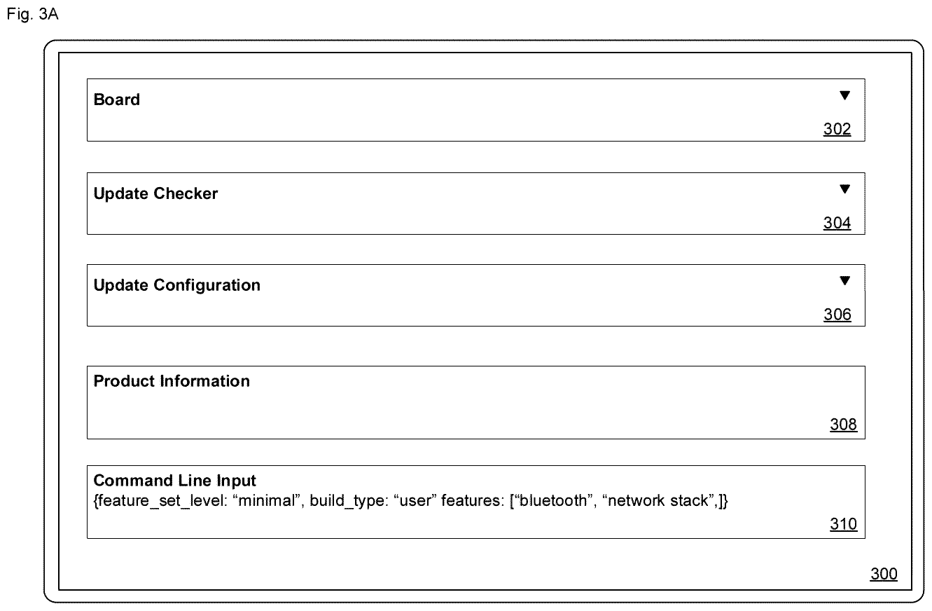

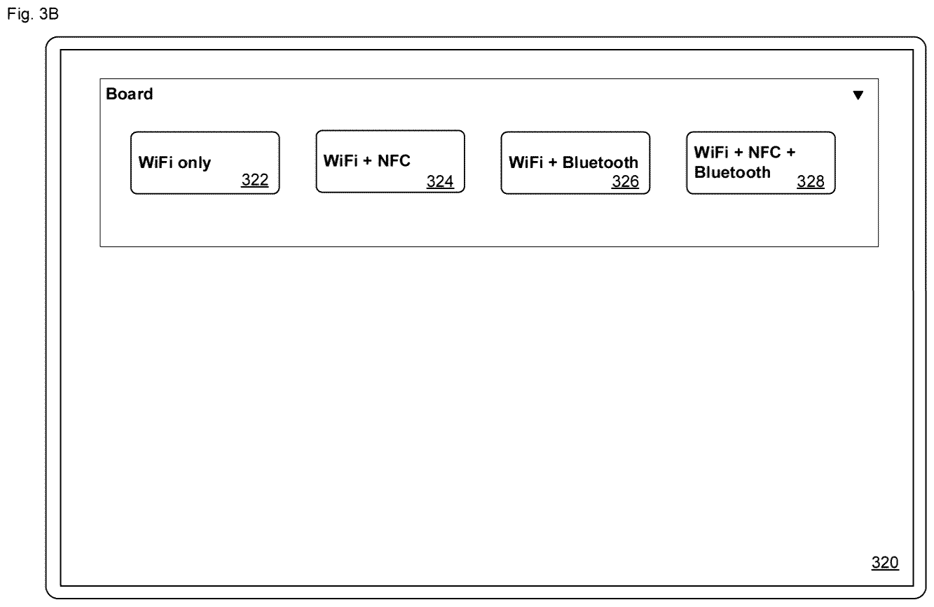

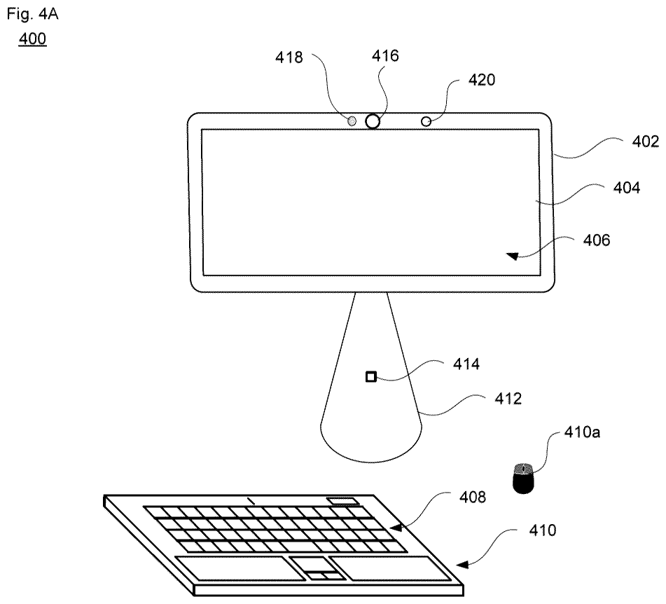

FIG. 2 shows a high-level illustration using an assembly tool as discussed herein. A developer 202 can interact with assembly tool 204 to generate a product image 206 according to the assembly flow described with regard to FIG. 1. FIG. 3A illustrates one example of a user interface 300 for the assembly tool. As shown, it may provide a set of dropdown menus such as board 302 (e.g., to select hardware or firmware elements), update checker 304, update configuration 306, etc. It may also include a text box 308 so that the developer can input information about the product. Alternatively or additionally, the UI 300 may employ a command line input section 310.

In one example 320 shown in FIG. 3B, the board drop-down 302 from FIG. 3A has been selected. Here, depending on the particular features supported by the board, the drop-down may show a set of options for specific components, such as WiFi. In this example, the UI may show options for WiFi only 322, WiFi plus near-field communication (NFC) 324, WiFi plus Bluetooth™ 326, and/or WiFi plus NFC plus Bluetooth™. In this scenario, the user can select which WiFi-related option should be enabled. Note that the UI for the assembly tool provides for the mutual exclusion of certain elements. For instance, selecting a board with WiFi (e.g., any of 322-328) may also prompt the user to choose whether WiFI should be enabled. And for a board without WiFi, such an enablement option should not be presented. Here, the board drop-down may not present any WiFi options, or may show such options greyed out (to indicate they are not selectable).

### Example Computing Devices

The technology can be applied in product assembly for many different types of computing devices. A few such examples are illustrated in the figures and discussed below.

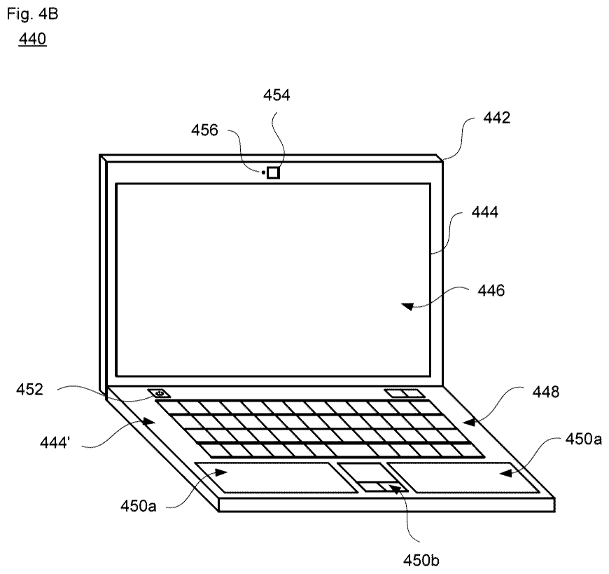

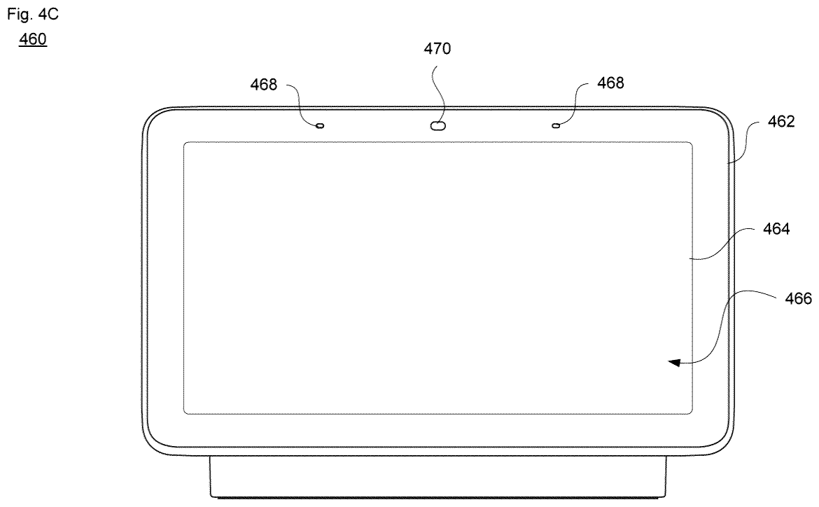

FIG. 4A illustrates a view 400 of an example desktop-type computing device 402. In this example, a single display 404 is shown, although multiple display devices may be supported. In one scenario, the display 404 may be configured for tactile input using a stylus or touch input with the user's finger(s) to interact with a graphical user interface (GUI) 406 presented on the display. As shown, the computing device 402 may employ a wireless keyboard 408 and/or one or more trackpads or mousepads 410, which may be part of one unit or the keyboard may be separate from the trackpad/mousepad or a mouse-based input 410a. Alternatively, the keyboard and/or other user inputs may have a wired connection to the computing device 402. As shown in this example, the computing device has a stand 412. One or more microphones 414 may be disposed along the stand and/or disposed along the housing of the integrated client device 402. While the computing device may be fixedly mounted to the stand 412, in an alternative configuration the screen (with the integrated components) can be detached from the stand, allowing a user to carry around the home and use remotely based on battery power. In other words, the client device can comprise an integrated housing that is (optionally removably or releasably) coupled to the stand 412.

In this example, a webcam or other integrated camera 416 that may include a privacy shutter or other feature to disable image-taking is positioned along the housing of the computing device 402, which can be used for videoconferences, interactive gaming, etc. Indicator 418, such as an LED, may be illuminated to alert a user whenever the webcam 416 is in use. The integrated client device may include a separate camera or other imaging device 420 that is part of a presence sensor. As shown, the webcam 416 and the imaging device 420 may each be positioned along a top bezel of the integrated client device housing. In some examples these devices may be located in different position along the integrated housing. The integrated camera 416 may be used as part of the presence sensor instead of or in addition to imaging device 420. In other words, the presence sensor comprises an image sensor configured to take one or more images. The presence sensor can be configured to detect presence of one or more people within a threshold distance from the client computing device.

FIG. 4B illustrates view 440 of an example laptop computer 442, such as a netbook. In this example, a display 444 is shown. In one scenario, the display 444 may be configured for tactile input using a stylus or touch input with the user's finger(s) to interact with a graphical user interface (GUI) 446 presented on the display. As shown, the laptop 442 may employ a keyboard 448 and/or one or more trackpads 450a and/or mousepads 450b. These input devices 448 and 450 may be virtual input devices presented on a second display 444′. In this case, the laptop computer 442 may also function as a dual-screen device. One or more microphones 452 may be disposed along the housing of the computer 442. The laptop computer 442 may include a webcam or other integrated camera 454 that may include a privacy shutter or other feature to disable image-taking is positioned along the housing, which can be used for videoconferences, interactive gaming etc. Indicator 456, such as an LED, may be illuminated to alert a user whenever the webcam 454 is in use. Similar to the computing device 402, the laptop computer 442 may include a separate camera or other imaging device, other than the webcam 454, that is part of a presence sensor.

FIG. 4C illustrates view 460 of an example interactive home appliance 462, such as an at-home assistant device. In this example, a display 464 is shown. In this example, the appliance 462 does not include a keyboard. In one scenario, the display 464 may be configured for tactile input using a stylus or touch input with the user's finger(s) to interact with a graphical user interface (GUI) 446 presented on the display. Alternatively or additionally to this, the interactive home appliance 462 may be configured to detect contactless gesture input, such as using a close range radar sensor (not shown), acoustical sensors (e.g., a microphone array) 468, cameras such as webcam 4, etc. In this arrangement, the camera(s) 470 may be part of a presence sensor. The devices shown in FIGS. 4A-C are merely exemplary. For instance, the interactive applicant may be a smart speaker or smart thermostat (or other smart appliance), which may not include a camera, and have LEDs instead of a display device.

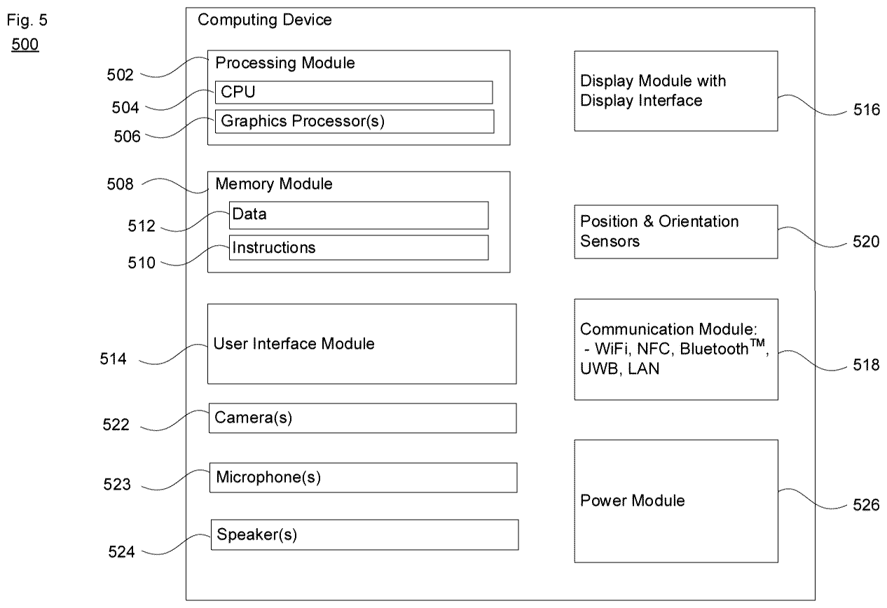

FIG. 5 illustrates a block diagram 500 of an example computing device such as a desktop-type device, laptop-type device or interactive home appliance-type device discussed above. As shown, the computing device includes a processing module 502 having one or more computer processors such as a central processing unit 504 and/or graphics processors 506, as well as memory module 508 configured to store instructions 510 and data 512. The processors may or may not operate in parallel, and may include ASICs, controllers and other types of hardware circuitry. The processors are configured to receive information from a user through user interface module 514, and to present information to the user on a display device of the display module 516 via the user interface module. The display module 516 has a display interface and may be configured as a touchscreen that enables user input via a stylus or other tool, or by the user physically touching the screen. Alternatively or additionally, contactless gesture input and/or audio input may be supported.

User interface module 514 is configured to receive user input. User interface module 514 may receive commands from a user via user inputs and convert them for submission to a given processor. The user interface module may link to a web browser (not shown). The user inputs may include a touchscreen as noted above, in addition to or alternatively from a keyboard, keypad, mousepad and/or touchpad, microphone, gesture-based input or other types of input devices. The keyboard, keypad, mousepad and/or touchpad may be part of or connectable to the computing device via a cable or other wired connection, or may physically separate from the integrated client device and configured to connect via one or more wireless connections such as Bluetooth™, WiFi, ultra-wideband (UWB), infrared, etc. The user interface module 514 can be operatively connected to the display module 516.

The display module 516 may comprise circuitry for driving the display device to present graphical and other information to the user. In other words, the display device is configured to present visual content. By way of example, the graphical information may be generated by the graphics processor(s) 506, while central processing unit (CPU) 504 manages overall operation of the computing device. The graphical information may display responses to user queries on the display module 516. For instance, the processing module may run a browser application, gaming application, enterprise app or other service using instructions and data stored in memory module 508, and present information to the user via the display module 516. The memory module 508 may include a database or other storage for browser information, game state information, location information, etc.

Memory module 508 can be implemented as one or more of a computer-readable medium or media, a volatile memory unit or units, or a non-volatile memory unit or units. The memory module 508 may include, for example, unmanaged flash memory and/or NVRAM (which may be NAND-based memory), and may be embodied as a hard-drive or memory card such as an embedded multimedia card (eMMC) or solid state drive (SSD) card (e.g., “managed NAND” or “managed memory”). Alternatively, the memory module 508 may also include removable media (e.g., DVD, CD-ROM or USB thumb drive). According to one aspect, the memory module 508 may be configured to have multiple partitions.

One or more regions of the memory module 508 may be write-capable while other regions may comprise read-only (or otherwise write-protected) memories. In one implementation, a computer program product is tangibly embodied in an information carrier. Although FIG. 5 functionally illustrates the processor(s), memory module, and other elements of integrated client device as being within the same overall block, such components may or may not be stored within the same physical housing. For example, some or all of the instructions and data may be stored on an information carrier that is a removable storage medium connectable to the base or the display housing (e.g., optical drive, high-density tape drive or USB drive) and others stored within a read-only computer chip which is integrated into the base or the display housing.

The data 512 may be retrieved, stored or modified by the processors in accordance with the instructions 510. For instance, the data may be stored in computing device registers, in a relational database as a table having a plurality of different fields and records. XML documents or flat files. The data may also be formatted in any computing device-readable format. The instructions 510 may be any set of instructions to be executed directly (such as machine code) or indirectly (such as scripts) by the processor(s). For example, the instructions may be stored as computing device code on the computing device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in example 500 of FIG. 5, the computing device includes a communication module 518 for communicating with other devices and systems, including other computing devices (e.g., a user's mobile phone or wearable computing device), servers and databases. The communication module 518 includes a wireless transceiver; alternatively, the module may alternatively or additionally include a wired transceiver. The computing device may communicate with other remote devices via the communication module 518 using various configurations and protocols, including short range communication protocols such as near-field communication (NFC), Bluetooth™, Bluetooth™ Low Energy (BLE), UWB or other ad-hoc networks, the Internet, intranets, virtual private networks, wide area networks, local networks, private networks using communication protocols proprietary to one or more companies, Ethernet, WiFi and HTTP, and combinations of the foregoing.

In addition, the example device as shown includes one or more position and orientation sensors 520. The position and orientation sensors 520 are configured to determine the position and orientation of one or more parts of the computing device, such as the display module relative to the base. For example, these components may include a GPS receiver to estimate the integrated client device's latitude, longitude and/or altitude, as well as an accelerometer, gyroscope or another direction/speed detection device such as an inertial measurement unit (IMU) capable of determining the orientation of the display housing relative to the base (as well as the rate of change of the positioning of the display housing).

The computing device may also include one or more camera(s) 522 for capturing still images and recording video streams such as an integrated webcam and/or a dedicated imaging device for presence sensing as discussed above. The device may also include one or more microphones 523 (which can be used for instruction input and/or presence sensing, e.g., by detecting acoustic information within the threshold distance from the client device), speakers 524, as well as a power module 526. Actuators to provide tactile feedback or other information to the user may be incorporated into the touchscreen of the display module (not shown).

### Example Network

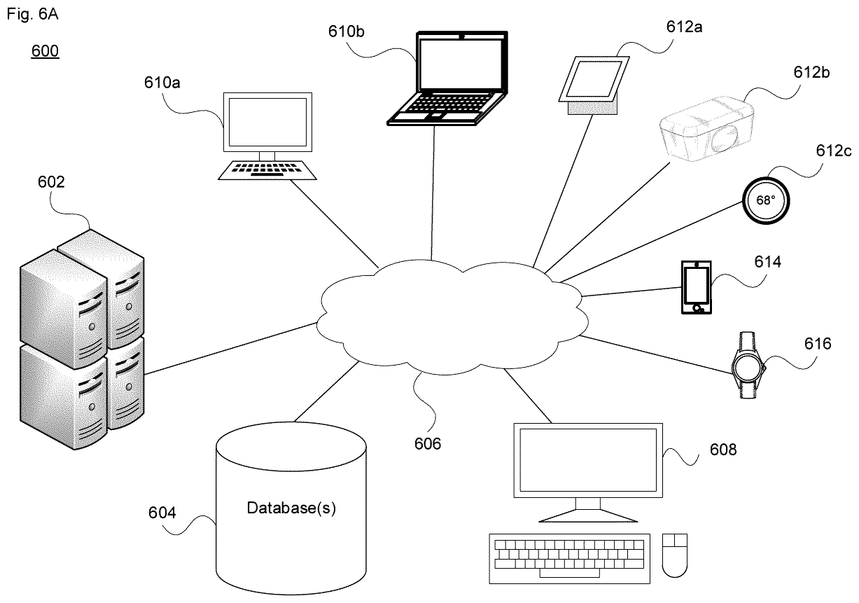

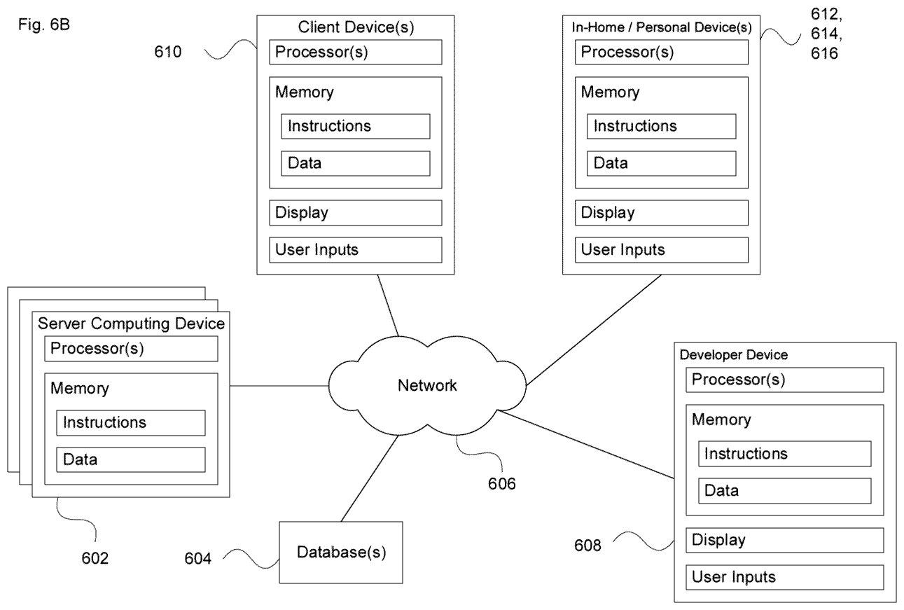

Various types of products can be updated using the product assembly process discussed above. In different scenarios, updates may be performed on all devices in a product line, subsets (tranches) of devices for the product line, on multiple different product lines, etc. One example computing architecture that may be employed in these approaches is shown in FIGS. 6A and 6B. In particular, FIGS. 6A and 6B are pictorial and functional diagrams, respectively, of an example system 600 that includes a plurality of computing devices and databases connected via a network. For instance, computing device(s) 602 may be a cloud-based server system that provides or otherwise supports updates for various products. Database(s) 604 may store the updates as well as other information associated with the products and/or platforms. The server system may access the databases via network 606.

Developer device 608 may be a workstation or other computing device that can run the product SDK, which may include the assembly tool. Products may include one or more of a desktop computer 610a, a laptop or tablet PC 610b, in-home devices such as may be moveable units (such as an at-home assistant device 612a or a smart speaker 612b), or fixed (such as a temperature/thermostat unit 612c). Other products may include a personal communication device such as a mobile phone or PDA 614 or a wearable device 616 such as a smartwatch, etc.

In one example, computing device 602 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 602 may include one or more server computing devices that are capable of communicating with the develop device 608 and any of the products 610-616 via the network 606. Here, the server computing devices may implement one or more product update services, which may correspond to the different types of products.

As shown in FIG. 6B, each of the computing devices 602, developer device 608 and products 610-616 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 6B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 602. Accordingly, references to a processor or computing device will be understood to include references to a collection of processors or computing devices or memories that may or may not operate in parallel.

The developer device 608 and the products 610-616 may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices that is operable to display information (e.g., text, imagery and/or other graphical elements). Other output devices, such as speaker(s) may also provide information to users.

The develop device 608 and/or the products 610-616 may communicate with a back-end computing system (e.g., server 602) via one or more networks, such as network 606. The network 606, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

### Exemplary Method of Operation

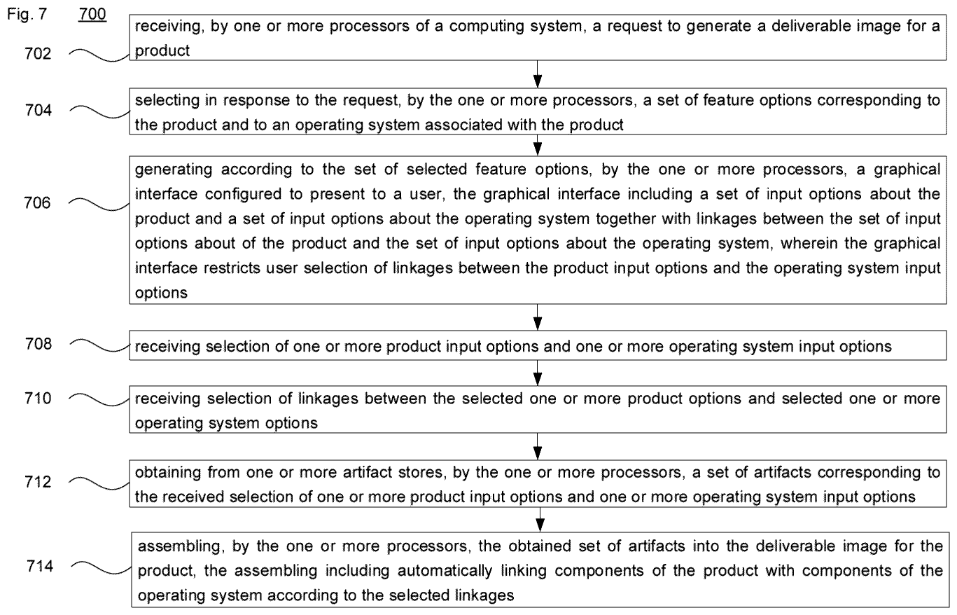

FIG. 7 illustrates a computer-implemented method 700 embodying aspects of the technology. The method includes, at block 702, receiving, by one or more processors of a computing system, a request to generate a deliverable image for a product. At block 704 the method includes selecting in response to the request, by the one or more processors, a set of feature options corresponding to the product and to an operating system associated with the product. Then at block 706 the method includes generating according to the set of selected feature options, by the one or more processors, a graphical interface configured to present to a user. The graphical interface includes a set of input options about the product and a set of input options about the operating system together with linkages between the set of input options about of the product and the set of input options about the operating system. The graphical interface restricts user selection of linkages between the product input options and the operating system input options. At block 708 the method includes receiving selection of one or more product input options and one or more operating system input options, and at block 710 receiving selection of linkages between the selected one or more product options and selected one or more operating system options. At block 712 the method includes obtaining from one or more artifact stores, by the one or more processors, a set of artifacts corresponding to the received selection of one or more product input options and one or more operating system input options. Then at block 714 the method includes assembling, by the one or more processors, the obtained set of artifacts into the deliverable image for the product. Here, the assembling includes automatically linking components of the product with components of the operating system according to the selected linkages.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method, comprising
receiving, by one or more processors of a computing system, a request to generate a deliverable image for a product;
selecting in response to the request, by the one or more processors, a set of feature options corresponding to the product and to an operating system associated with the product;
generating according to the set of selected feature options, by the one or more processors, a graphical interface configured to present to a user, the graphical interface including a set of input options about the product and a set of input options about the operating system together with linkages between the set of input options about of the product and the set of input options about the operating system, wherein the graphical interface restricts user selection of linkages between the product input options and the operating system input options;
receiving selection of one or more product input options and one or more operating system input options;
receiving selection of linkages between the selected one or more product options and selected one or more operating system options;
obtaining from one or more artifact stores, by the one or more processors, a set of artifacts corresponding to the received selection of one or more product input options and one or more operating system input options; and
assembling, by the one or more processors, the obtained set of artifacts into the deliverable image for the product, the assembling including automatically linking components of the product with components of the operating system according to the selected linkages.

2. The method of claim 1, wherein assembling the set of artifacts into the deliverable image for the product includes validating an assembly configuration to ensure that a set of correct artifacts are present to produce the deliverable image.

3. The method of claim 1, wherein the graphical interface generated to include the set of input options about the operating system does not include any platform-internal components of the operating system.

4. The method of claim 1, wherein obtaining the set of artifacts includes retrieving product-related artifacts from given ones of the one or more artifact stores that are associated with the product.

5. The method of claim 4, wherein obtaining the set of artifacts further includes retrieving operating system-related artifacts directly from an operating system artifact store.

6. The method of claim 4, wherein the one or more artifact stores associated with the product includes at least one of a product artifact store, an external artifact store, or a driver artifact store.

7. The method of claim 1, wherein assembling the set of artifacts into the deliverable image for the product includes constraining one or more configuration values in the deliverable image.

8. The method of claim 7, wherein:
the one or more configuration values include at least a pair of configuration values; and
constraining the one or more configuration values includes preventing the pair of configuration values from being used with one another.

9. The method of claim 7, wherein constraining the one or more configuration values includes restricting access for a given resource to specific operating system components.

10. The method of claim 1, wherein any artifacts from the set of artifacts corresponding to the one or more operating system input options are hashed operating system components.

11. The method of claim 1, further comprising:
receiving a request to modify the deliverable image;
in response to receiving the request, updating a configuration file for the deliverable image; and
compiling a modified version of the deliverable image without recompiling any artifacts associated with the operating system.

12. The method of claim 1, wherein the set of input options about the product corresponds to compiled components for one or more product features.

13. The method of claim 1, further comprising storing the deliverable image in a product release archive.

14. The method of claim 1, further comprising sending the deliverable image to one or more product devices for installation thereon.

15. A system, comprising:
a set of artifact stores each configured to store a specific type of software component; and
one or more processors operatively coupled to the set of artifact stores, the one or more processors being configured to:
receive a request to generate a deliverable image for a product;
select, in response to the request, a set of feature options corresponding to the product and to an operating system associated with the product;
generate, according to the set of selected feature options, a graphical interface configured to present to a user, the graphical interface including a set of input options about the product and a set of input options about the operating system together with linkages between the set of input options about of the product and the set of input options about the operating system, wherein the graphical interface is configured to restrict user selection of linkages between the product input options and the operating system input options;
receive selection of one or more product input options and one or more operating system input options;
receive selection of linkages between the selected one or more product options and selected one or more operating system options;
obtain, from the set of artifact stores, a set of artifacts corresponding to the received selection of one or more product input options and one or more operating system input options; and
assemble the obtained set of artifacts into the deliverable image for the product, the assembly including automatic linking of components of the product with components of the operating system according to the selected linkages.

16. The system of claim 15, wherein assembly of the set of artifacts into the deliverable image for the product includes validation of an assembly configuration to ensure that a set of correct artifacts are present to produce the deliverable image.

17. The system of claim 15, wherein obtaining the set of artifacts includes retrieval of product-related artifacts from one or more artifact stores of the set of artifact stores associated with the product.

18. The system of claim 15, wherein assembly of the set of artifacts into the deliverable image for the product includes constraint of one or more configuration values in the deliverable image.

19. The system of claim 18, wherein the constraint of the one or more configuration values includes restriction of access for a given resource to specific operating system components.

20. The system of claim 15, wherein the one or more processor are further configured to:
receive a request to modify the deliverable image;
in response to receiving the request, update a configuration file for the deliverable image; and
compile a modified version of the deliverable image without recompiling any artifacts associated with the operating system.
